(19) United States
(12) Patent Application Publication
(10) Pub. No.: US 2007/0126367 A1
(43) Pub. Date: Jun. 7, 2007

(54) Startup circuit and backlight control circuit using same

(75) Inventors: Tong Zhou, Shenzhen (CN); Kun Le, Shenzhen (CN)

Correspondence Address: WEI TE CHUNG;FOXCONN INTERNATIONAL, INC., 1650 MEMOREX DRIVE, SANTA CLARA, CA, 95050, US

(73) Assignee: INNOLUX DISPLAY CORP.

(21) Appl. No.: 11/633,283

(22) Filed: Dec. 4, 2006

(30) Foreign Application Priority Data
Dec. 2, 2005 (TW) 94142479

(51) Int. Cl. H05B 39/04

(52) U.S. Cl. 315/209 R; 315/224

(57) ABSTRACT

A backlight control circuit (300) used in a liquid crystal display includes a startup circuit (330), and a pulse width modulation integrated circuit (320). The startup circuit includes a charging terminal, a first capacitor (331) connected between the charging terminal and ground, a second capacitor (332), and a current limiting resistor (333). The second capacitor and the current limiting resistor are connected in series between ground and the charging terminal. The pulse width modulation integrated circuit includes an inspecting pin (321) connected to the charging terminal of the startup circuit. The pulse width modulation integrated circuit generates a startup pulse signal before a voltage of the inspecting pin is higher than a predetermined threshold voltage.

### FIELD OF THE INVENTION

The present invention relates to a startup circuit, and a backlight control circuit having the startup circuit; the backlight control circuit typically being part of a backlight module used in a liquid crystal display (LCD).

### GENERAL BACKGROUND

An LCD has the advantages of portability, low power consumption, and low radiation, and has been widely used in various portable information products such as notebooks, personal digital assistants (PDAs), video cameras and the like. Furthermore, the LCD is considered by many to have the potential to completely replace CRT (cathode ray tube) monitors and televisions.

A typical LCD includes an LCD panel, one or more backlights for illuminating the LCD panel, and a backlight control circuit for controlling the backlights. The backlight control circuit includes an inverter circuit for driving the backlights, a pulse width modulation integrated circuit (PWM IC) for driving the inverter circuit, and a startup circuit for starting the PWM IC. The backlights can be cold cathode fluorescent lamps or light emitting diodes (LEDs). If the backlights are cold cathode fluorescent lamps, the PWM IC generates a startup pulse signal with a high frequency to light up the backlights, and generates a driving signal with a low frequency to drive the backlights. Generally, the startup circuit is connected to the PWM IC, and is used to carry out the starting function.

FIG. 4 is a block diagram of a typical backlight control circuit used in an LCD, together with a backlight. The backlight control circuit 100 includes a PWM IC 120, a startup circuit 130, and an inverter circuit 140 for driving the backlight 150. The PWM IC 120 is used to control the inverter circuit 140, and includes an inspecting pin 121. The startup circuit 130 is essentially a capacitor 131, which is connected between the inspecting pin 121 and ground.

When an external power supply (not shown) is provided to the PWM IC 120, the PWM IC 120 charges the capacitor 131 via the inspecting pin 121. Before a voltage of the inspecting pin 121 is charged to a level higher than a threshold voltage, the PWM IC 120 generates a startup pulse signal and provides the startup pulse signal (as shown in FIG. 5) to the inverter circuit 140. The inverter circuit 140 lights up the backlight 150 according to the startup pulse signal. A duration of the startup pulse signal is determined by a charging time of the capacitor 131. The backlight 150 is typically a cold cathode fluorescent lamp (CCFL).

After the voltage of the inspecting pin 121 is charged to a level higher than the threshold voltage, the PWM IC 120 generates a driving signal and provides the driving signal to the inverter circuit 140. The inverter circuit 140 drives the backlight 150 according to the driving signal.

Because the startup circuit 130 of the backlight control circuit 100 is essentially only a capacitor 131, the backlight control circuit 100 has following disadvantage. When the external power supply is provided to the PWM IC 130, the capacitor 131 of the startup circuit 130 is fully charged via the inspecting pin 121 in a very short time. That is, the charging time of the capacitor 131 is short time. Thererfore, the voltage of the inspecting pin 121 is charged to a level higher than a threshold voltage in a very short time. As a result, the duration of the startup pulse signal is liable to be inadequate to meet the demand for lighting up the backlight 150. That is, the backlight 150 cannot be lighted up by the short startup pulse signal.

It is desired to provide a new startup circuit and a corresponding backlight control circuit which overcome the above-described deficiencies.

### SUMMARY

In a preferred embodiment, a backlight control circuit used in a liquid crystal display includes a startup circuit, and a pulse width modulation integrated circuit. The startup circuit includes a charging terminal, a first capacitor connected between the charging terminal and ground, a second capacitor, and a current limiting resistor. The second capacitor and the current limiting resistor are connected in series between ground and the charging terminal. The pulse width modulation integrated circuit includes an inspecting pin connected to the charging terminal of the startup circuit. The pulse width modulation integrated circuit is configured to generate a startup pulse signal before a voltage of the inspecting pin is higher than a predetermined threshold voltage.

Advantages and novel features of the above-described circuits will become more apparent from the following detailed description when taken in conjunction with the accompanying drawings.

### BRIEF DESCRIPTION OF THE DRAWINGS

FIG. 1 is a block diagram of a backlight control circuit according to a first embodiment of the present invention, together with a backlight.

FIG. 2 is an abbreviated signal wave diagram of a startup pulse signal generated by a PWM IC of the backlight control circuit of FIG. 1.

FIG. 3 is a block diagram of a backlight control circuit according to a second embodiment of the present invention, together with a backlight.

FIG. 4 is a block diagram of a conventional backlight control circuit used in an LCD, together with a backlight.

FIG. 5 is an abbreviated signal wave diagram of a startup pulse signal generated by a PWM IC of the backlight control circuit of FIG. 4.

### DETAILED DESCRIPTION OF PREFERRED EMBODIMENTS

Reference will now be made to the drawings to describe the present invention in detail.

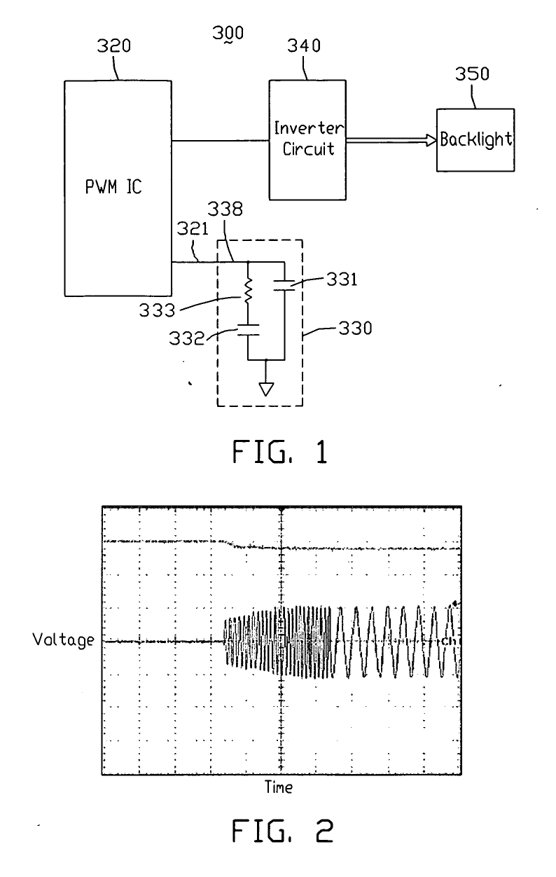

FIG. 1 is a block diagram of a backlight control circuit according to a first embodiment of the present invention, together with a backlight. The backlight control circuit 300 is typically used in an LCD having the backlight 350. The backlight control circuit 300 includes a PWM IC 320, a startup circuit 330, and an inverter circuit 340 for driving the backlight 350. The backlight 350 is typically a cold cathode fluorescent lamp.

The startup circuit 330 includes a charging terminal 338, a first capacitor 331 connected between the charging terminal 338 and ground, and a current limiting resistor 333 and a second capacitor 332 connected in series between the charging terminal 338 and ground. A capacitance of the first capacitors 331 is equal to 0.068 μF. A capacitance of the second capacitor 332 is equal to 0.33 μF. A resistance of the current limiting resistor 333 is equal to 500Ω.

The PWM IC 320 includes an inspecting pin 321 connected to the charging terminal 338. The PWM IC 320 is used to control the inverter circuit 340. The inverter circuit 340 drives the backlight 350.

When an external power supply (not shown) is provided to the PWM IC 320, the PWM IC 320 charges the startup circuit 330 via the inspecting pin 321. Before a voltage of the inspecting pin 321 is charged to a level higher than a predetermined threshold voltage, the PWM IC 320 generates a startup pulse signal (as shown in FIG. 2) and provides the startup pulse signal to the inverter circuit 340. Then the inverter circuit 340 lights up the backlight 350 according to the startup pulse signal. The duration of the startup pulse signal is determined by a charging time “T” of the startup circuit 330.

After the voltage of the inspecting pin 321 is charged to a level higher than the predetermined threshold voltage, the PWM IC 320 generates a driving signal and provides the driving signal to the inverter circuit 340. The inverter circuit 340 drives the backlight 350 according to the driving signal.

The process of charging the startup circuit 330 is as follows. In a first period of time T1, the voltage of the charging terminal 338 is charged to a first voltage level V1 at a first charging speed. In a second period of time T2, the voltage of the charging terminal 338 is charged from V1 to the predetermined threshold voltage at a second charging speed. The first period of time T1 is determined by the two parameters of the capacitance of the second capacitor 332 and the resistance of the current limiting resistor 333. The second period of time T2 is determined by the parameter of the capacitance of the first capacitor 331. The charging time “T” of the startup circuit 330 equals T1 plus T2.

Because the current limiting resistor 333 can limit a charging current for charging the second capacitor 332, the charging time Ti can be adjusted to be sufficiently long. Thus the duration of the startup pulse signal provided by the PWM IC 320 to the inverter circuit 340 is adequate to meet the demand for lighting up the backlight 350. Thus even if the number of backlights 350 is increased to two or more, the PWM IC 320 of the backlight control circuit 300 can generate an appropriate startup pulse signal to light up the backlights 350.

However, if the capacitance of the first capacitor 331 is too large, when the PWM IC 320 is powered off, the electric charge on the first capacitor 331 may not be discharged quickly. To avoid this problem, the PWM IC 320 may be continuously reset, because the voltage of the charging terminal 321 is always higher than the predetermined threshold voltage.

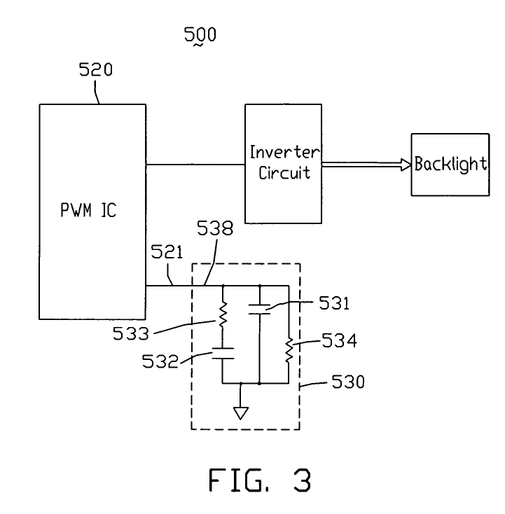

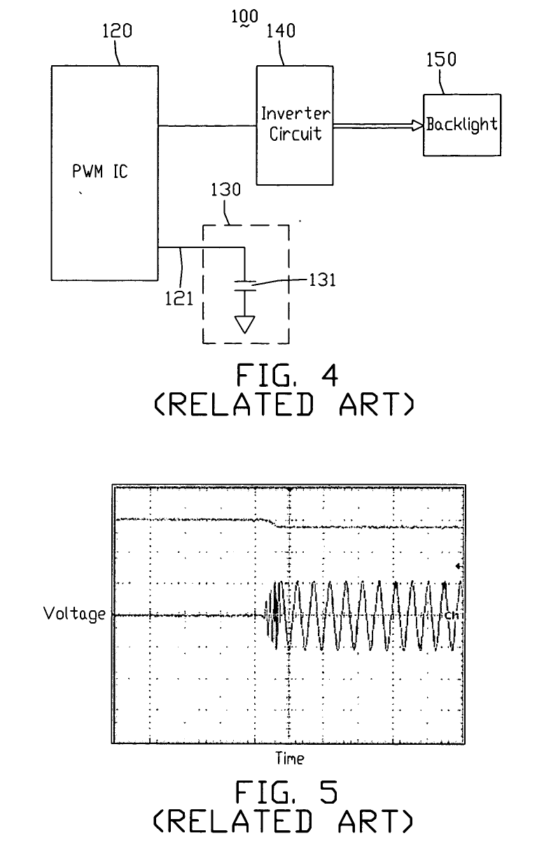

FIG. 3 is an abbreviated diagram of a backlight control circuit according to a second embodiment of the present invention, together with a backlight. The backlight control circuit 500 is similar to the backlight control circuit 300. However, the backlight control circuit 500 includes a startup circuit 530, and a PWM IC 520 having an inspecting pin 521. The startup circuit 530 includes a charging terminal 538, a first capacitor 531, a discharging resistor 534, a second capacitor 532, and a current limiting resistor 533. The first capacitor 531 and the discharging resistor 534 are connected in parallel between the charging terminal 538 and ground. The current limiting resistor 533 and the second capacitor 532 are connected in series between the charging terminal 538 and ground. The charging terminal 538 is connected to the inspecting pin 521 of the PWM IC 520. A capacitance of the first capacitor 531 is equal to 0.068 μF. A capacitance of the second capacitor 532 is equal to 0.33 μF. A resistance of the current limiting resistor 533 is equal to 500Ω. A resistance of the discharging resistor 534 is equal to 1MΩ.

When the PWM IC 520 is powered off, the electric charge on the first capacitor 531 can be discharged quickly via the discharging resistor 534. Therefore, the PWM IC 520 can be powered off normally. Thus, the discharging resistor 534 avoids any need to continuously reset the PWM IC 520 in order to quickly discharge the electric charge on the first capacitor 531.

In order to improve the driving capability of the backlight control circuit 500 or the starting speed of the backlight control circuit 500, the parameters of the startup circuit 530 can be adjusted as follows.

When the capacitance of the first capacitor 531, the capacitance of the second capacitor 532, the resistance of the current limiting resistor 533, and the resistance of the discharging resistor 534 are respectively equal to 0.01 μF, 0.1 μF, 200Ω, and 1MΩ, the backlight control circuit 500 achieves a fast starting speed.

When the capacitance of the first capacitor 531, the capacitance of the second capacitor 532, the resistance of the current limiting resistor 533, and the resistance of the discharging resistor 534 are respectively equal to 0.1 μF, 1μF, 1KΩ, and 2MΩ, the backlight control circuit 500 achieves good driving capability.

Accordingly, the capacitance of the first capacitor 531, the capacitance of the second capacitor 532, the resistance of the current limiting resistor 533, and the resistance of the discharging resistor 534 can be adjusted to respectively be in the ranges from 0.01 μF-0.1 μF, 0.1 μF-1 μF, 200Ω-1KΩ, and 1MΩ-2MΩ.

Alternatively, the startup circuit 530 of the backlight control circuit 500 can be used in other types of integrated circuits that are used for soft starting.

It is to be understood, however, that even though numerous characteristics and advantages of the preferred embodiments have been set out in the foregoing description, together with details of the structures and functions of the embodiments, the disclosure is illustrative only; and that changes may be made in detail, especially in matters of shape, size, and arrangement of parts within the principles of present invention to the full extent indicated by the broad general meaning of the terms in which the appended claims are expressed.

What is claimed is:

1. A backlight control circuit used in a liquid crystal display, comprising:
a startup circuit comprising:
a charging terminal;
a first capacitor connected between the charging terminal and ground;
a current limiting resistor and a second capacitor connected in series between the charging terminal and ground; and
a pulse width modulation integrated circuit comprising an inspecting pin connected to the charging terminal of the startup circuit;
wherein the pulse width modulation integrated circuit is configured to generate a startup pulse signal before a voltage of the inspecting pin is higher than a predetermined threshold voltage.

2. The backlight control circuit as claimed in claim 1, wherein capacitances of the first and second capacitors are respectively approximately equal to 0.01 μF and 0.1 μF.

3. The backlight control circuit as claimed in claim 2, wherein a resistance of the current limiting resistor is approximately equal to 200Ω.

4. The backlight control circuit as claimed in claim 1, wherein capacitances of the first and second capacitors are respectively approximately equal to 0.068 μF and 0.33 μF.

5. The backlight control circuit as claimed in claim 4, wherein a resistance of the current limiting resistor is approximately equal to 500Ω.

6. The backlight control circuit as claimed in claim 1, wherein capacitances of the first and second capacitors are respectively approximately equal to 0.1 μF and 1 μF.

7. The backlight control circuit as claimed in claim 6, wherein a resistance of the current limiting resistor is approximately equal to 1KΩ.

8. The backlight control circuit as claimed in claim 1, further comprising a discharging resistor connected between the charging terminal and ground.

9. The backlight control circuit as claimed in claim 1, further comprising an inverter circuit configured for driving a backlight and connected to the pulse width modulation integrated circuit, wherein the startup pulse signal is used to light up the backlight via the inverter circuit.

10. The backlight control circuit as claimed in claim 9, wherein the backlight is a cold cathode fluorescent lamp.

11. A startup circuit for an integrated circuit (IC), comprising:
a charging terminal;
a first capacitor connected between the charging terminal and ground; and
a current limiting resistor and a second capacitor connected in series between the charging terminal and ground.

12. The startup circuit as claimed in claim 11, further comprising a discharging resistor connected between the charging terminal and ground.

13. The startup circuit as claimed in claim 11, wherein capacitances of the first and second capacitors are respectively approximately equal to 0.01 μF and 0.1 μF.

14. The startup circuit as claimed in claim 13, wherein a resistance of the current limiting resistor is approximately equal to 200Ω.

15. The startup circuit as claimed in claim 11, wherein capacitances of the first and second capacitors are respectively approximately equal to 0.068 μF and 0.33 μF.

16. The startup circuit as claimed in claim 15, wherein a resistance of the current limiting resistor is approximately equal to 500Ω.

17. The startup circuit as claimed in claim 11, wherein capacitances of the first and second capacitors are respectively approximately equal to 0.1 μF and 1 μF.

18. The startup circuit as claimed in claim 17, wherein a resistance of the current limiting resistor is approximately equal to 1KΩ.

19. The startup circuit as claimed in claim 11, wherein said IC is a pulse width modulation IC.
